(19) United States
(12) Patent Application Publication
(10) Pub. No.: US 2024/0296967 A1
(43) Pub. Date: Sep. 5, 2024

(54) METHODS AND SYSTEMS FOR PREDICTING FATIGUE ACCUMULATION

(71) Applicant: GE-Hitachi Nuclear Energy Americas LLC, Wilmington, NC (US)

(72) Inventors: Panagiotis TSILIFIS, Troy, NY (US); Ahmad Waleed Ahmad Foaad AMER, Latham, NY (US); KMK Genghis KHAN, Niskayuna, NY (US)

(73) Assignee: GE-Hitachi Nuclear Energy Americas LLC, Wilmington, NC (US)

(21) Appl. No.: 18/399,016

(22) Filed: Dec. 28, 2023

Related U.S. Application Data
(60) Provisional application No. 63/449,730, filed on Mar. 3, 2023.

(51) Int. Cl. G21D 3/06; G01M 5/00; G21C 17/112; G21D 3/00

(52) U.S. Cl. CPC G21D 3/06; G01M 5/0033; G21C 17/112; G21D 3/001

(57) ABSTRACT

A method of identifying at least one critical location on a physical structure includes receiving operational information related to an operation of the physical structure, the operational information including different time instances of the operation of the physical structure and the operation of the physical structure at different operational levels; predicting damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations; and identifying the at least one critical location on the physical structure based on the predicted damage.

### CROSS-REFERENCE TO RELATED APPLICATIONS

This application claims priority under 35 U.S.C. § 119 to U.S. Provisional Application No. 63/449,730 filed on Mar. 3, 2023, the entire contents of which are hereby incorporated by reference in their entirety.

### GOVERNMENT LICENSE RIGHT

This invention was made with government support under DE-AR0001295 awarded by the Advanced Research Projects Agency-Energy (ARPA-E). The government has certain rights in the invention.

### BACKGROUND

### Field

The present disclosure relates to physical structures which accumulate fatigue and damage with use and/or systems for monitoring use of the physical structures and estimating and predicting fatigue and damage accumulation.

### Description of Related Art

Physical structures such as, for example, energy plants and other equipment and sub-systems may accumulate fatigue and damage while in use. The fatigue and damage may accumulate from pressure, vibrations, heat, etc. Repairs may be eventually needed to counteract the accumulated fatigue and damage to inhibit (or, alternatively, prevent) the physical structure from becoming inoperable.

### SUMMARY

At least some example embodiments relate to a method of identifying at least one critical location on a physical structure.

In some example embodiments, the method includes receiving operational information, the operational information being information related to an operation of the physical structure, the operational information including different time instances of the operation of the physical structure and the operation of the physical structure at different operational levels, the operational levels relating to levels of output from the physical structure, at least a portion of the operational information being received from sensors sensing a condition of the physical structure; predicting damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations; and identifying the at least one critical location on the physical structure based on the predicted damage.

In some example embodiments, the method further includes generating a work order or alarm based on the at least one critical location and the at least one model.

In some example embodiments, the at least one model includes one or more machine learning regression models or machine learning time-series models.

In some example embodiments, the operational information includes available time series data indicating stress or material temperature within the physical structure and unavailable time series data where stress or material temperature within the physical structure is unknown, and wherein the predicting damage to the physical structure includes predicting initial damage to the physical structure by: interpolating the operational information to forecast additional operational information at a same location or angle on the physical structure across the different operational levels of the physical structure associated with the unavailable time series data; and concatenating the operational information and the additional operational information for a specified prediction time period to generate complete operational information.

In some example embodiments, the predicting the initial damage to the physical structure further includes: performing rainflow counting (RC) using a simplified RC algorithm to count a number of cycles in the complete operational information; estimating a number of cycles to initiation of the damage at locations or angles of the physical structure where the operational information or the additional operational information is available; predicting a number of cycles to initiation of the damage at different locations or angles where the complete operational information is unavailable by using machine learning models to quantify a level of uncertainty in the number of cycles to initiation of the damage; and calculating damage fraction at each cycle of the number of cycles in in the complete operational information using

$$D = {\sum }_{i = 1}^{k} \frac{{n}_{i}}{{N}_{i}} ≪ 1 ,$$

wherein “D” is the damage fraction, “k” is a number of stress levels, “nᵢ” is a number of accumulated cycles, and “Nᵢ” is the number of cycles to the initiation of the damage at an i-th stress.

In some example embodiments, the initial damage includes at least one of fatigue damage, creep damage, oxidation damage, or wear damage of the physical structure, the fatigue damage including a surface crack or a subsurface crack in the physical structure.

In some example embodiments, the predicting damage to the physical structure further includes predicting growth of the initial damage to the physical structure over time based on:

$$\frac{d {a}_{n}}{d n} = c {{K}_{eff} ( {a}_{n} )}^{m} ,$$

where “aₙ” is crack length under cycle n and includes a level of uncertainty in the number of cycles to initiation of the damage, “c” and “m” are material coefficients with a level of uncertainty for the physical structure, “K_{eff}” is an effective stress intensity factor computed based on a stress level (On) and a crack geometry using

$${K}_{eff} = K ( {σ}_{n} , {a}_{n} ) \sqrt{1 - \frac{{σ}_{n , min}}{{σ}_{n , max}}} ,$$

where “σ_{n,min}” is a minimum stress and “σ_{n,max}” is a maximum stress, and K(σₙ, aₙ) is a stress intensity factor that varies based on a geometry of the initial damage to the physical structure and the physical structure.

In some example embodiments, the predicting damage to the physical structure is further based on operating a digital twin of the physical structure, the digital twin being an electronically generated model of the physical structure.

In some example embodiments, the condition of the physical structure includes temperature data and flow rate data, and the method further includes updating the condition of the physical structure at the at least one critical location; and updating the at least one model based on the updated condition of the physical structure at the at least one critical location.

In some example embodiments, the physical structure is included in a nuclear power plant that further includes a nuclear reactor, and the operational levels are power output levels of the nuclear reactor.

In some example embodiments, the operational information includes repair and installation details for the physical structure.

In some example embodiments, the method further includes controlling a device to change the condition at the physical structure based on the at least one critical location and the at least one model.

Some example embodiments relate to a device configured to identify at least one critical location on a physical structure.

In some example embodiments, the device includes processing circuitry configured to, receive operational information, the operational information being information related to an operation of the physical structure, the operational information including different time instances of the operation of the physical structure and the operation of the physical structure at different operational levels, the operational levels relating to levels of output from the physical structure, at least a portion of the operational information being received from sensors sensing a condition of the physical structure, predict damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations, and identify the at least one critical location on the physical structure based on the at least one model.

In some example embodiments, the processing circuitry is further configured to generate a work order or alarm based on the at least one critical location and the at least one model.

In some example embodiments, the at least one model includes one or more machine learning regression models or machine learning time-series models.

In some example embodiments, the operational information includes available time series data indicating stress or material temperature within the physical structure and unavailable time series data where stress or material temperature within the physical structure is unknown, and wherein the processing circuitry is configured to predict the damage to the physical structure by predicting at least initial damage to the physical structure by: interpolating the operational information to forecast additional operational information at a same location or angle on the physical structure across the different operational levels of the physical structure associated with the unavailable time series data; and concatenating the operational information and the additional operational information for a specified prediction time period to generate complete operational information.

In some example embodiments, the processing circuitry is configured to predict the initial damage to the physical structure by further: performing rainflow counting (RC) using a simplified RC algorithm to count a number of cycles in the complete operational information; estimating a number of cycles to initiation of the damage at locations or angles of the physical structure where the operational information or the additional operational information is available, predicting a number of cycles to initiation of the damage at different locations or angles where the complete operational information is unavailable by using machine learning models to quantify a level of uncertainty in the number of cycles to initiation of the damage; and calculating damage fraction at each cycle of the number of cycles in in the complete operational information using

$$D = {\sum }_{i = 1}^{k} \frac{{n}_{i}}{{N}_{i}} ≪ 1 ,$$

wherein “D” is the damage fraction, “k” is a number of stress levels, “nᵢ” is a number of accumulated cycles, and “Nᵢ” is the number of cycles to the initiation of the damage at an i-th stress.

In some example embodiments, the predicting damage to the physical structure is further based on operating a digital twin of the physical structure, the digital twin being an electronically generated model of the physical structure, and the initial damage includes at least one of fatigue damage, creep damage, oxidation damage, or wear damage of the physical structure, the fatigue damage including a surface crack or a subsurface crack in the physical structure.

In some example embodiments, the processing circuitry is further configured to control another device to change the condition at the physical structure based on the at least one critical location and the model.

Some example embodiments relate to a non-transitory computer readable medium including instructions thereon, which when executed by a processor cause the processor to receive operational information, the operational information being information related to an operation of a physical structure, the operational information including different time instances of the operation of the physical structure and the operation of the physical structure at different operational levels, the operational levels relating to levels of output from the physical structure, at least a portion of the operational information being received from sensors sensing a condition of the physical structure, predict damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations, and identify at least one critical location on the physical structure based on the at least one model.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a block diagram of a device according to some example embodiments.

FIG. 2 is a schematic view of an energy plant according to some example embodiments.

FIG. 3 is a diagram of modeling of a physical reactor.

FIG. 4 is a flow diagram of operations performed by the device.

FIG. 5 illustrates an example of concatenating stress signals times series over example time periods to produce a daily or annual operational routine.

FIG. 6 is an example of historical data at different power levels.

FIG. 7 is an example of simulated stress signals at different power levels.

FIG. 8 is an example of rainflow counting and detected cycles.

FIG. 9 is an example of uncertainty quantification for identifying critical locations for crack initiation.

FIG. 10 is an example of propagation of a crack over time cycles.

### DETAILED DESCRIPTION

Some detailed example embodiments are disclosed herein. However, specific structural and functional details disclosed herein are merely representative for the purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” “attached to,” “adjacent to,” or “covering” another element or layer, it may be directly on, connected to, coupled to, attached to, adjacent to or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

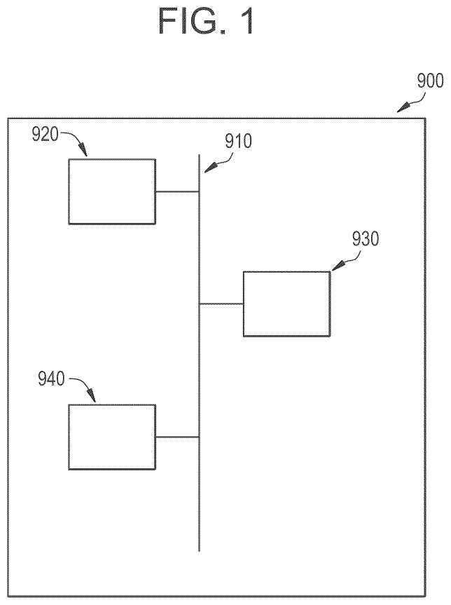

FIG. 1 is a block diagram of a device according to some example embodiments.

There is demand to reduce the cost of design, construction and operation of various structures by, for example, reducing lifecycle maintenance costs through, for example, reducing the size of components used in these various structures, increasing the modularity of components included in the structure to reduce the costs associated with repairing and replacing the components during the lifecycle, and/or reducing the number of onsite personal necessary to operate the structure.

Such structures may include, for example, industrial power generation turbines, aircraft engines, wind turbines, and nuclear reactors amongst other engineering structures. In the context of nuclear reactors, one type of structure being explored to accomplish the above goals are small modular reactors (SMRs). SMRs are designed to reduce the levelized cost of electricity from the reactor through design features that include reducing the partitioning inside the reactor, reducing the overall size of the reactor components, whilst increasing modularity. These design features are implemented with the purpose of reducing the cost of operation and construction of SMRs compared to regular boiling water reactors. Further, SMRs are designed to allow for the use of commercial off-the-shelf equipment outside of the reactor core and chimney (e.g., turbines, generators, etc.). For maintenance, SMRs modularity is key. For instance, in some SMRs, fuel assemblies, chimney head, control rods, steam separator assembly, steam dryers and in-core instrumentation assemblies and much of the internals of the reactor may be removable for ease of maintenance. This said, with cost in mind, the permanent staff onsite is also reduced. For instance, outage activities may require a temporary support team that is not part of the permanent staffing.

These unique features of SMRs (specifically reduced size of core/chimney and reduced staffing), and the fact that SMRs are designed with reduced cost and maintenance operations in mind, dictate that a more elaborate monitoring procedure for the condition of the reactor needs to be applied in order to further optimize maintenance operations and outage schedules.

However, the structures including industrial power generation turbines, aircraft engines, wind turbines, and nuclear reactors including SMRs, may experience various forms of damage including fatigue damage such as cracks or subsurface cracks, creep damage, oxidation damage, or wear damage. After the occurrence of such damage, the physical structure may be compromised, and the damage may then propagate over time. Such damage may increase the lifecycle maintenance costs due to, for example, the costs associated with monitoring for the occurrence of such damage as well as repairing and replacing damaged parts.

As discussed in more detail below, to accomplish the goal of reducing operational and maintenance costs, example embodiments are directed to building a digital twin simulation of a physical structure to predict both the initial damage to one or more components of the physical structure and propagation of this damage once such damage is predicted to likely occur.

According to example embodiments, the digital twin allows for maintaining the structure only on a need-to basis, not based off a schedule that is independent of the condition of the structure, thus reducing the cost of unnecessary maintenance operations. The digital twin, according to example embodiments, also plays a role in automating the monitoring of the structure, which overcomes any shortages in staffing.

While the digital twin is discussed below in the context of nuclear reactors, such as SMRs, the digital twin according to example embodiments may be applied to analyse damage to any physical structure that that exhibits damage in the form of cracking, be it induced by fatigue, creep, wear, oxidation, or other physical phenomena.

Referring to FIG. 1, in some example embodiments, a device 900 (which may be an electronic device, computer, computing device, and/or equipment according to any of the example embodiments) may be configured to perform any of the methods, steps, operations, or the like as described herein according to any of the example embodiments. The device 900 may include a processor 920, a memory 930, and an interface 940 that are electrically coupled together via a bus 910. The interface 940 may be a communication interface (e.g., a wired or wireless communication transceiver). The interface 940 may be communicatively coupled to one or more external devices such as other processing devices, sensors, memories, etc.

The memory 930, which may be a non-transitory computer readable medium, may store a program of instructions and/or other information. The memory 930 may be a non-volatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM). The processor 920 may be configured to execute the stored program of instructions to perform one or more functions. For example, the processor 920 may execute programs of instruction stored at the memory 930 to control various equipment, operations, or the like of an energy plant, including but not limited to a nuclear power plant (also referred to herein interchangeably as a nuclear plant). The processor 920 may execute programs of instruction stored at the memory 930 to perform any of the methods, operations, functionality, or the like of any of the example embodiments, including for example generating, maintaining, and/or operating a virtual twin (e.g., digital twin) of one or more physical structures, articles of equipment, processes, or the like of various structures or systems, including for example an energy plant.

One or more of the processor 920, the memory 930, and/or the interface 940 may be included in, include, and/or implement one or more instances of processing circuitry such as hardware including logic circuits, a hardware/software combination such as a processor executing software; or a combination thereof. In some example embodiments, said one or more instances of processing circuitry may include, but are not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc. In some example embodiments, any of the memories, memory units, or the like as described herein may include a non-transitory computer readable storage device, for example a solid state drive (SSD), storing a program of instructions, and the one or more instances of processing circuitry may be configured to execute the program of instructions to implement the functionality of some or all of any of the processor 920, memory 930, interface 940, or the like according to any of the example embodiments as described herein, including performing any of the operations of any of the methods according to any of the example embodiments.

The device 900 may be configured to perform (e.g., based on the processor 920 executing a program of instructions stored at the memory 930) various methods according to any of the example embodiments, including for example a method comprising: receiving stress time series historical data that includes stress values across different time instances during different first operational levels of a physical structure, the stress time series historical data being generated based on sensors sensing conditions of the physical structure at a first plurality of locations at the physical structure; applying Gaussian process regression and Autoregressive timeseries models to the stress time series historical data, to interpolate and forecast stress values across the different operational levels of the physical structure and locations at the physical structure to predict at least one stress time series for damage analysis across operational levels and/or locations at the physical structure with no available stress data among the different operational levels and locations at the physical structure; performing concatenation of the stress timeseries historical data and the predicted stress timeseries in order to generate predicted stress time series data that matches a prediction time period; performing Rainflow Counting (RC) on the predicted stress time series data, using a simplified RC algorithm and a selected operational level of the first and second operational levels, to count a number of cycles in the predicted stress time series data; calculating a number of cycles to crack initiation (Nᵢ) for each cycle in the predicted stress time series data and subsequently calculating damage accumulation and quantifying uncertainty at arbitrary locations at the physical structure at each cycle using Miner's law; identifying a most critical location among the arbitrary locations at the physical structure for which a lowest predicted value of N_{I} is predicted for each cycle using a Gaussian process regression model to predict N_{I} at the arbitrary locations of the physical structure, the arbitrary locations including locations where no sensor is present.

A digital twin simulation of the physical structure may be performed at least by applying Autoregressive timeseries models and Gaussian process regression to the stress time series historical data, where the autoregressive timeseries models describe certain time-varying processes that depends linearly on its own previous values and on a stochastic term (an imperfectly predictable term). In contrast, Gaussian process regression may be a nonparametric representation of a stochastic process that generalizes to spatial variables and characterizes the state of a quantity of interest (e.g., stress) as a function of the location, given observations at different locations.

For example, the digital twin may apply Autoregressive timeseries models to interpolate and forecast stress values across the different operational levels of the physical structure and locations at the physical structure to predict at least one stress time series for damage analysis across operational levels and/or locations at the physical structure with no available stress data among the different operational levels and locations at the physical structure; performing concatenation of the stress timeseries historical data and the predicted stress timeseries in order to generate predicted stress time series data that matches a prediction time period requested by an operator; performing Rainflow Counting (RC) on the predicted stress time series data, using a simplified RC algorithm and a selected operational level of the first and second operational levels, to count a number of cycles in the predicted stress time series data; calculating a number of cycles to crack initiation (Nᵢ) for each cycle in the predicted stress time series data and subsequently calculating damage accumulation and quantifying uncertainty at arbitrary locations at the physical structure at each cycle using Miner's law. The digital twin may apply the Gaussian Process regression models to select critical locations on the component of interest by identifying the locations at which the stress levels create a scenario in the damage analysis indicates crack initiation at the lowest number of operational cycles N_{I}.

The operator may request that the digital twin run to simulate, for example, a daily operational regime combining multiple power level shifts for a set time period. The digital twin will use the stress/temperature timeseries it has, forecast any missing stress/temperature timeseries, then concatenate the proper timeseries to simulate the daily operational regime for the set time period requested by the operator.

The physics model that the digital twin encompasses contains parameters (materials-related parameters, noise terms, and the initial crack size) that are uncertain by nature. While the Gaussian Process regression model is used to quantify these uncertainties to the best the initial stress data has to offer, the digital twin may calibrated using real-world data, and a Bayesian calibration algorithm within the digital twin calibrates the parameters within the digital twin to make the predictions better match the true operational data. For example, additional information from the sensors may be input as new historical data and the digital twin simulation may be rerun based on the new historical data. Parameters of the digital twin simulation may also be adjusted based on the new historical data being compared to the calculated damage accumulation. Simulations of propagation of cracks and other damage may also be performed based on Paris' law using the digital twin simulation.

The device 900 may be attached to, or incorporated into, a control system of an energy plant, including for example a nuclear plant, according to any of the example embodiments. For example, the device 900 may be included in an EMP control system of a nuclear plant (as shown in FIG. 1) of U.S. patent application Ser. No. 17/490,052, which is incorporated by reference herein. The device 900 may also be connected directly or indirectly to various sensors located at (e.g., on and/or within) various equipment, physical structures, or the like in the nuclear plant. The device 900 may receive sensor data generated by the sensors (e.g., as historical data as described herein) directly or indirectly.

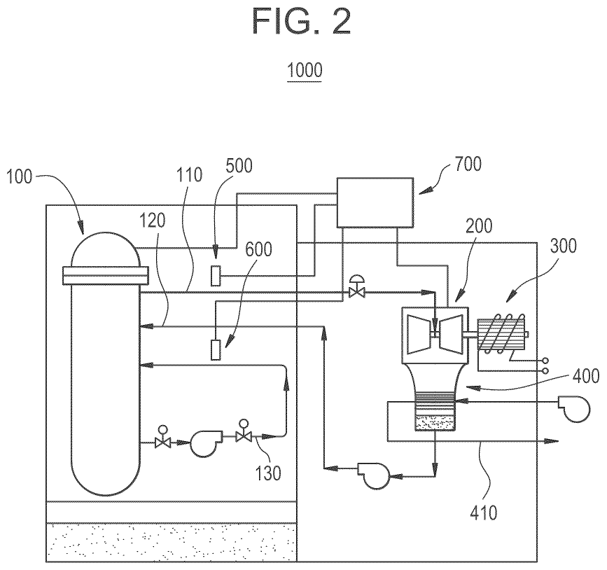

FIG. 2 is a schematic view of an energy plant according to some example embodiments. Such an energy plant may be a nuclear plant that includes a nuclear reactor and is configured to be operated to cause the nuclear reactor to generate power (e.g., heat, electrical power, etc.). The energy plant 1000 may include a reactor enclosure system 100 (for example, a reactor module that may include a nuclear reactor, for example a reactor module including a reactor pressure vessel further including a nuclear reactor), a turbine 200, and a condenser 400 and may further include a control system 700, but example embodiments are not limited thereto. A first conduit 110 may lead from the reactor enclosure system 100 to the turbine, and a second conduit 120 may lead from the condenser 400 to the to the reactor enclosure system 100. The turbine 200 and the condenser 400 may be connected. A heated working fluid (including, for example, a coolant which may include steam, water, liquid metal coolant, gas working fluid, etc.) transmitted through the first conduit 110 may pass through the turbine 200 to turn the turbine 200 which turns a generator 300 to produce electricity (e.g., generate electrical power). Subsequent to passing through the turbine 200, the working fluid may be cooled by the condenser 400. A coolant conduit 410 may supply a separate working fluid (e.g., a second coolant) that is pumped from (and returned to) a local reservoir (e.g., a body of water such as a river) to provide the requisite heat exchange in the condenser 400 to cool the working fluid. The cooled working fluid in the condenser 400 may then be supplied (e.g., pumped) back to the reactor enclosure system 100 via a feed conduit 120 to repeat the cycle, thereby establishing a coolant loop. The working fluid in the reactor enclosure system 100 may also be recirculated through a recirculation conduit 130 (e.g., via a recirculation pump external to the reactor enclosure system 100 and a jet pump within the reactor enclosure system 100) to control the power level of the nuclear reactor in the reactor enclosure system 100 or to cool the reactor enclosure system 100 during an off-normal state, but example embodiments are not limited thereto and such a recirculation conduit may be omitted.

In some example embodiments, multiple sensors, such as a first sensor 500 and a second sensor 600 may be coupled, positioned, or the like to measure a physical condition of one or more portions, physical structures, equipment, or the like of the energy plant 1000. For example, the first sensor 500 and the second sensor 600 may be any known temperature sensors, vibration sensors, radiation sensors, accelerometers, etc. which may measure the moisture carryover (MCO) in the energy plant 1000, temperature, radiation level, acceleration (e.g., vibration), translation (e.g., translation from deformation or displacement), etc. In some example embodiments, the first and second sensors 500 and 600 may be any known stress measurement sensors. The first sensor 500 and the second sensor 600 may generate sensor data which may be provided (e.g., transmitted via a communication link) to a computing device such as control system 700 as historical data.

Although the first sensor 500 and the second sensor 600 are illustrated as being implemented in connection with the first conduit 110 and the recirculation conduit 130, respectively, it should be understood that example embodiments are not limited thereto. The accompanying drawings are merely intended to help convey the overarching concepts of the present methods and systems for measuring moisture carryover and, thus, are not meant to be limiting. As a result, it should be understood that the first sensor 500 and the second sensor 600 may be implemented in connection with other suitable conduits/lines, tanks, and other structures consistent with the teachings herein.

The energy plant 1000 may also include a control system 700 which receives information (e.g., sensor data) from the first sensor 500 and the second sensor 600. The control system 700 may include a computing device (e.g., the computing device 900 shown in FIG. 1) that is configured to perform any of the methods, operations, or the like according to any of the example embodiments. The control system 700 may be communicatively coupled to, and configured to control operations of, one or more articles of equipment of the energy plant 1000 to operate the energy plant 1000, for example to cause a nuclear reactor included in the reactor enclosure system 100 to generate power.

Although the first sensor 500 and the second sensor 600 are depicted on conduits of the energy plant 1000 that may include a steam type power generation system, example embodiments are not limited thereto. The first sensor 500 and the second sensor 600 may be located in other locations of the steam type power generation system (such as fittings, boilers, turbines, pipes, support structures, etc.) or on other forms of systems such as pipelines, molten salt reactors, hydraulic power plant, geothermal power plant, non-condensing power plant, etc. The principles disclosed herein may apply to any physical structure and are not limited to the disclosed example embodiments.

The control system 700 may include the device 900 shown in FIG. 1 and may perform a method, one or more operations, or the like according to any of the example embodiments, for example based on the processor 920 of the device 900 executing instructions stored on the memory 930 of the device 900. The historical data may be input (e.g., received) at the device 900 from one or more of the sensors 500, 600, or the like of the energy plant 1000 via the interface 940 and may be stored on the memory 930.

The control system 700 may provide any of several forms of output (using the device 900 or other hardware) based on the digital twin simulation and methods described herein according to any of the example embodiments. For example, the control system 700 may output (e.g., transmit, via an alarm, a display interface, a light emitting diode (LED) display, or the like) an indication of areas of predicted damage or areas needing inspection, including a most critical location for inspection or repair. The control system 700 may output an alert or alarm, including visual and/or audio information via displays and speakers (not shown), based on the digital twin simulation and the historical data and/or any methods according to any of the example embodiments. The control system 700 may output (e.g., transmit) recommendations for maintenance or inspection. The control system 700 may modify operation of the energy plant 1000 (e.g., adjust operation of a nuclear plant including a nuclear reactor within the reactor enclosure system 100) based on the digital twin simulation (e.g., lowering power output of the nuclear reactor until an inspection can be completed to reduce risk of damage). The control system 700 may modify a schedule of the nuclear reactor based on the digital twin simulation including cycles and power output level. The control system 700 may implement a computer learning protocol trained using the historical data to perform the digital twin simulation and provide the various outputs of the control system 700. The control system 700 may adjust simulations of the digital twin based on newly acquired historical data which is acquired in real time while the nuclear reactor is in operation.

In some example embodiments, the energy plant 1000 may be a nuclear plant that includes a nuclear reactor, within the reactor enclosure system 100, that is a boiling water reactor (BWR), but example embodiments are not limited thereto. For example, the energy plant 1000 including the control system 700, and device 900, or the like, configured to perform any of the methods according to any of the example embodiments may include a nuclear reactor that may include any type of nuclear reactor, including but not limited to a Boiling Water Reactor (BWR), a Pressurized Water Reactor (PWR), a liquid metal cooled reactor (e.g., a Sodium cooled Fast Reactor (SFR)), a Molten Salt Reactor (MSR), an Advanced Boiling Water Reactor (ABWR), an Economic Simplified Boiling Water Reactor (ESBWR), a Small Modular Reactor (SMR), a BWRX-300 reactor, or the like.

While some example embodiments, including the example embodiments shown in FIG. 2, include an energy plant which may include a nuclear reactor (e.g., a nuclear plant), example embodiments are not limited thereto, and a device configured to perform any of the methods according to any of the example embodiments may be located in various systems, processes, or the like (e.g., a factory, a fossil fuel power plant, or the like).

According to some example embodiments, a nuclear plant according to any of the example embodiments may be operated to cause a nuclear reactor thereof to generate power (e.g., heat, electrical power, or the like). Such a nuclear plant may include the energy plant 1000 as shown in FIG. 2 or may include other examples of nuclear plants. Accordingly, it will be understood that a method according to some example embodiments may include a method of operating a nuclear plant according to any of the example embodiments, where the method includes generating power (e.g., heat, electrical power, or the like) using a nuclear reactor of a nuclear plant according to any of the example embodiments.

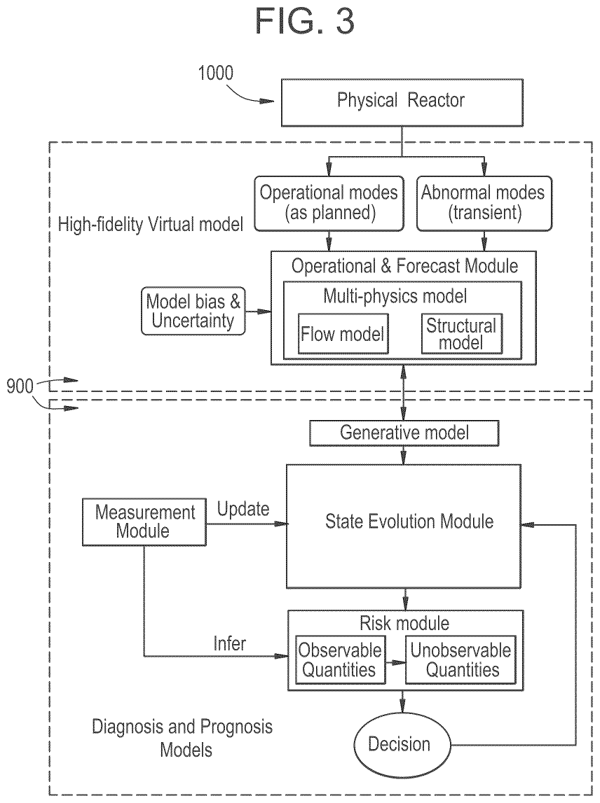

FIG. 3 is a diagram of modeling of a physical structure, such as the energy reactor 1000) or other physical structure. Restated, the properties and characteristics of the physical reactor may be modeled in the device 900. The physical structure may be modeled using a digital twin, which is a digital simulation using models that can replace costly and lengthy physical tests while supporting the performance of predictive maintenance to, thus, allowing for the reduction in operation and maintenance costs.

The model of the physical reactor may include physical characteristics such as the size of various elements, the materials of the elements, the age and estimated accumulated fatigue of the elements of the physical reactor. Examples of elements of the physical reactor (or, alternatively, the other physical structure) include reactor, pipes, support structures, connection fittings, mounts, compressor blades, gears, chambers, walls, containment structures, pumps, sensors, wires, reservoirs, controllers, gates, valves, generators, etc. Sub-components of these various elements may also be simulated. The elements may be simulated in great detail. For example, for a pipe, the length, diameter, thickness, material, age, and installation method may be simulated. Thus, the device 900 may generate a high-fidelity model of the physical reactor (or, alternatively, the other physical structure). The modes of operation of the physical reactor, both (planned) operational modes and (transient) abnormal modes may be simulated. Examples of the operational modes include operation at different power levels (e.g., 10% power, 20% power, etc. for a reactor) and transitions between power levels. Abnormal modes can be observed when transitioning between extreme power levels (such as going from 20% to 100% and vice versa) where the fluid flow takes some time to reach steady state in the new operational level and the observed signals can be abnormal for a short period of time. Also any rapid and unplanned transition can cause similar effects.

The device 900 may be separated into modules including a high-fidelity virtual model and a diagnosis and prognosis model, both of which may be implemented by the processor 920 through the execution of code that transforms the processor 920 into a special purpose processor to perform the functions of these models. The goal of the high-fidelity model is to generate rich databases with different ranges of operational modes and/or design parameters.

The high-fidelity virtual model may include an operation and forecast module that may simulate physical reactor in the operation modes and abnormal modes. For example, the processor 920 may execute code that transforms the processor 920 into a special purpose processor to perform the functions of the operation and forecast module including generating a multi-physics model of the physical reactor that includes a structural model of the physical reactor and a flow model for liquids moving in the physical reactor. This could be a computational fluid dynamics (CFD) model that simulates multi-phase flow through a feedwater pipe etc. Restated, the device 900 may model the physical reactor in operation modes and abnormal modes according to the structural model of the physical reactor and the flow model of the physical reactor. The operation and forecast module may also take in model bias and uncertainty to improve modeling. For example, model bias and uncertainties can be quantified by the comparison with experimental data and resolved large eddy simulation (LES) solutions. The operation and forecast module may be a structure-based resolution of turbulence (STRUCT) model.

The thermal mixing in reactor piping involves medium-to-strong turbulence motion. Modelling turbulence can be computationally costly. LES provides accurate scale-modeling but is very computationally expensive. By using controlled resolution inside select flow regions, STRUCT can capture the physics of interest and reduce the operational cost by about a factor of two compared to LES. STRUCT excels at low frequency data, which is the primary cause of damage in physical reactors such as power reactors. Differences in modeling using LES and STRUCT compared to real measured results may be used to generate the model bias and uncertainty.

Thermal loads in piping of the physical reactor may be computed through the coupling of computational fluid dynamics and finite element analysis. The finite element analysis may be computed under isotropic linear elasticity and thermal expansion assumptions. The Gaussian Process regression models may perform Bayesian inference to quantify, propagate and update uncertainties associated with a unique model (e.g., a physical twin).

The diagnosis and prognosis model may include a measurement module, a state evolution module, and a risk module. For example, the processor 920 may execute code that transforms the processor 920 into a special purpose processor to perform the functions of the diagnosis and prognosis model such as the measurement module, the state evolution module, and the risk module.

Based on the operation and forecast mode results output from the high-fidelity virtual model, a generative model may be generated which includes stresses at model points of the digital twin of the physical reactor. The model points may be entirely independent of locations of sensors on the physical reactor. The model points may be located at any location of the digital twin of the physical reactor and may have a greater concentration around areas which are known to be points where fatigue and damage are acquired more quickly (for example, at junctures where fluids mix, at turns in piping, at thermal exchanges, at interfaces between different materials, etc.).

The generative model may be used in a state evolution module which simulates fatigue and damage to the physical structure at the model points based on the acquired stress to the physical structure at the model points. The state evolution module may also receive actual measurements from the physical reactor from a measurement module so that the simulations may be updated (for example, in real time). The measurement module may receive information directly or indirectly from sensors such as sensors 500, 600 or from a controller such as controller 700.

The state evolution module may predict damage to the physical structure or a probability of damage to a physical structure based on planned operation of the physical reactor. Damage may include fatigue damage such as a cracks, creep damage such as a rupture, oxidation damage such as a chemical erosion, or wear damage such as frictional damage from the movement of parts. Fatigue damage may be based on a number of operating cycles of over time while creep damage, oxidation damage and wear damage may be based on the length of operating time.

For example, model point 1 among the model points of the physical structure may be a point on a pipe at a t-junction in the physical reactor. The state evolution module may predict that a crack will form at model point 1 after 10,000 hours of the physical reactor operating at 100% output based on the stresses at model point 1 in the generative model. The state evolution module may also predict that the crack's propagation and predict when the crack will compromise functionality of the physical structure.

Damage may be accumulated from a variety of sources such as temperature and changes in temperature (and the associated expansion and compression of the materials with the changing in temperature), pressure and changes in pressure, movement (such a rotation of a compressor fan, or generator), erosion (from fluid movement), vibration, and radiation (from, nuclear fuel, heat, or outside sources such as sunlight). Different sensors may be included in the physical reactor to measure each of these sources of damage in some places. The digital twin of the physical reactor may simulate damage at many additional locations on the digital twin including locations where it is impractical to place sensors. The digital twin may be used to simulate the damage at the additional points based on the sensed data at the sensed points and may also be able to predict damage accumulation at the sensed points and the additional points based on planned operation of the physical reactor.

A risk module of the device 900 may determine possible damage and solutions to the damage based on the state evaluation by the state evaluation module, observable quantities, and unobservable quantities (which may be inferred from the observable quantities). The observable quantities may include measurements and historical data. The unobservable quantities may include stress intensity factors in critical regions or damage accumulation metrics. A risk value may be inferred through Bayesian inferences based on the observable and unobservable qualities. A decision can then be made based on the risks. For example, if the risks of a crack propagating until failure of a pipe are above a threshold value, a decision to lower output power of the physical reactor may be made. This decision can be fed back into the state evolution module to determine if this decision will result in a risk factor below the threshold value. As another example, the decision may be a work order or recommendation for a work order to repair the physical structure. The decision of diagnosis and prognosis models may be sent to a controller 700 of the energy plant 1000.

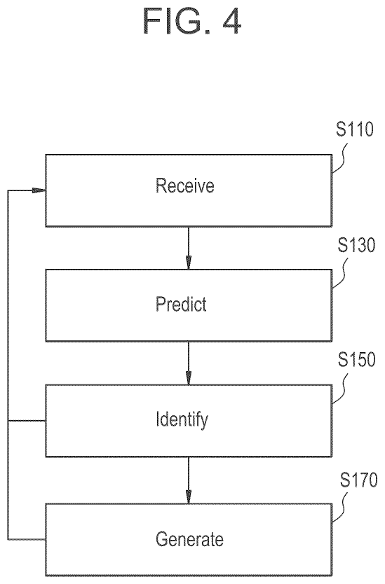

FIG. 4 is a flow diagram of operations performed by the device 900. At S110 the device 900 may receive operation information related to operation of a physical structure (for example, the physical structure of the energy plant 1000). The operation information may include different time instances of the operation of the physical structure. These time instances may be continuous (e.g., operation of the physical structure for the entire year or some other period of time) or discontinuous (e.g., operation of the physical structure during discontinuous sampling periods). The operation information may include different operational levels of the physical structure. For example, for an energy plant, operational levels may be different power output levels (as well as special operational levels, such as, output power levels for maintenance, testing, etc.) The output power levels may be evenly spaced such as spaced apart at 10% (e.g., 10%, 20%, 30%, 40%, 50%, 60%, 70%, 80%, 90%, and 100% of the maximum power output level). The output levels may also have unevenly spaced levels of power. For example, if ordinary power output is around 75%, the power levels in the operation information may be concentrated around the ordinary power output for greater detail around the ordinary power output (e.g., 5%, 25%, 50%, 60%, 65%, 70%, 75%, 80%, 85%, 100%). If continuous operation information is used it may be divided into operational levels based on the output level during sub-periods of the operation period. In this way, the device 900 may obtain operation information for each operational level.

The operation information may be received at the device 900 from controllers and sensors of the physical structure. For example, the device 900 may receive sensor data from the sensors 500, 600 and control information from the controller 700. The sensor data may be received directly from the sensors 500, 600 or indirectly. The sensor data may include temperature, vibration, fluid pressure, fluid movement speed, repetitions per minute, radiation level, or any other measurable physical property of the physical structure. The sensor data may be directly or indirectly received by the device 900. For example, if the device 900 is separate from the controller 700, the device 900 may receive the sensor data directly from the sensors 500, 600 or indirectly via the controller 700. The controller 700 and the device 900 in some embodiments may be the same device (e.g., the controller 700 both controls the operations of the energy plant 1000 and performs the operations described with relation to FIG. 4). The control information may include the controls of the physical structure (such as the energy plant 1000). The control information may include an output level of the physical structure and the sensor data may include the physical properties of the physical structure corresponding to the output level.

At S130, the device 900 predicts damage accumulation to the physical structure. The damage may be predicted based on the operation information, predicted operation of the physical structure with at least one of the different operational levels, and at least one model of the physical structure. The at least one model may include a digital twin of the physical structure. The digital twin may be an electronically generated model of the physical structure. The digital twin may include physical components of the physical structure. For example, for the energy plant 1000, the digital twin may include digital representations of the reactor 100, pipes 110, 120, and 130 turbine 200, generator 300, condensation chamber 400, and other structural elements of the energy plant 1000.

The predicting of damage to the physical structure may include assessing a condition of the physical structure. For example, if the historical data includes the entire operational history of the physical structure and repair, installation, and upkeep information of the physical structure, the current condition of the physical structure may be modeled. By knowing when a particular repair was conducted or when a scan or inspection of a component was performed, the condition may be predicted with greater accuracy. The condition of the physical structure may be updated each time additional historical data is received by, for example, resetting the model of the accumulated fatigue for the component upon replacement of the component. The additional historical data can be of multiple categories, either direct damage inspection “readings” or generic operational information such as the component being replaced or reactor outage or changes in operational power levels. All of this can be fed into the digital twin, which will in turn adjust its predictions to better match reality.

The at least one model may also include a gaussian regression model, an autoregressive timeseries model.

As part of the modeling, the operational information for the physical structure may be interpolated and forecasted for the future across some, all, and/or a combination of the different operational levels of the physical structure. For example, stresses for operating the physical structure at different operational levels may be predicted. For combinations of operational levels, the prediction may include concatenating the operation information in order to match a prediction time period.

For example, if it is planned to operate the energy plant 1000 at 75% power during the day and 50% power during the night for a month, the at least one model may be used to predict stress during the month caused by these operational levels by concatenating operational information from 75% power and 50% power together for the prediction period. For example, stress caused by heat change, liquid pressure, liquid movement, and radiation may be calculated. The predicted stress during the month may be used to forecast the damage accumulated by the physical structure at many points in the physical structure.

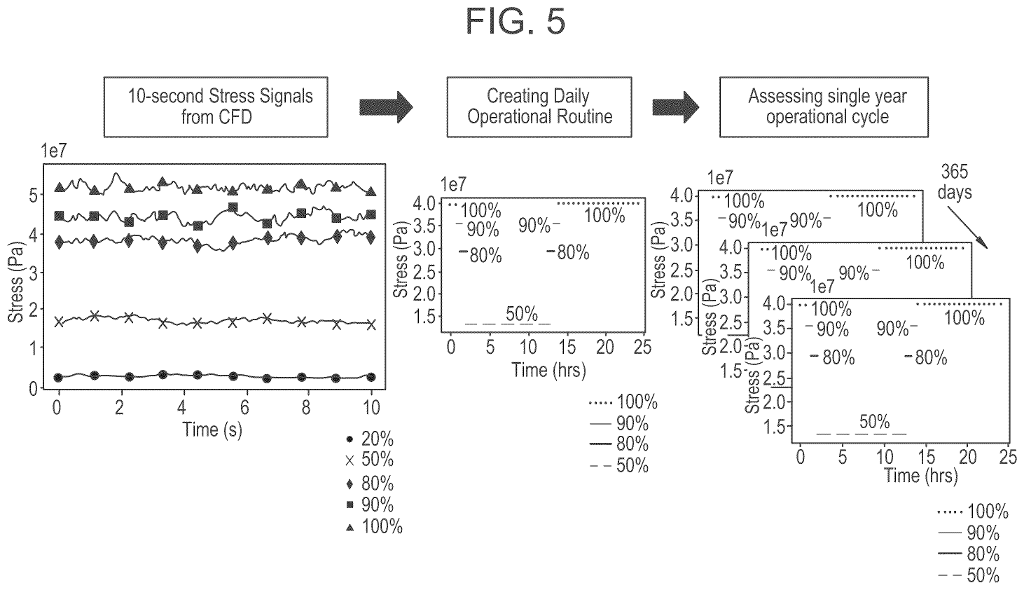

FIG. 5 illustrates an example of concatenating stress times series signals over example time periods to produce a daily or annual operational routine.

Referring to FIG. 5, the choice of operational levels being concatenated is related to the operation of the physical structure and can be changed on an hourly/daily basis to better cope with the operation of the physical structure. In addition, the amount of time spanned after concatenation can be adjusted to allow for physical structure downtimes such as maintenance operations and blackouts.

As illustrated in FIG. 5, stress data may be collected short time periods, for example, 10 seconds at various power levels (e.g., 50%, 80%, 90%, and 100%), and this data may be concatenated to produce data over longer time periods, for example a day or a year.

Referring back to FIG. 4, as discussed above, the model points and the predictions of damage at the model points may be independent of a proximity of sensors to each of the model points. For example, independent of the location of a flow rate sensor, the at least one model can predict flow rate at any point in the digital twin based on the sensor data and the operational level of the physical structure. Similarly, independent of the location of a temperature sensor, the temperature at any point of the physical structure can be modeled and predicted based on the sensor data, and the operational level of the physical structure. The predicted physical properties such as pressure, temperature, flow rate, etc. may be used to model damage accumulation at any point along the digital twin of the physical structure.

Predicting damage to the physical structure may include performing rainflow counting (RC) using a simplified RC algorithm to count a number of cycles in the operation information, and analyzing a number of cycles to initiation of the damage and then calculating damage accumulation at each cycle using Equation 1.

$$D = {\sum }_{i = 1}^{k} \frac{{n}_{i}}{{N}_{i}} ≪ 1 \qquad ( 1 )$$

In Equation 1, “D” is a damage fraction, “k” is a number of stress levels, “nᵢ” is a number of accumulated cycles at an i-th stress, and “Nᵢ” is an average number of cycles to the initiation of the damage at an i-th stress. Nᵢ may be obtained for each material being modeled. For example, 316L stainless steel pipes may be used and the Nᵢ for the 316L stainless steel may be obtained by the S-N data for 316L stainless steel. The device 900 may utilize Equation 1 to predict stress at locations where data is missing and identify the most critical locations by estimating Nᵢ at each location, and selecting the location at which cracking/damage is most likely to initiate (i.e. the location with the smallest Nᵢ).

Crack propagation may be described by Paris Law using Equation 2:

$$\frac{d {a}_{n}}{d n} = c {{K}_{eff} ( c )}^{m} \qquad ( 2 )$$

In equation 2 “aₙ” is crack length under cycle n. The material coefficients, “c” and “m” are obtained from a data-calibrated model of the material such as a 316L Fatigue Crack Growth (FCG) data-calibrated models for 316L stainless steel. The effective stress intensity factor, K_{eff}, can be computed based on the stress level(σₙ) and the crack geometry using equation 3:

$${K}_{eff} = K ( {σ}_{n} , {a}_{n} ) \sqrt{1 - \frac{{σ}_{n , min}}{{σ}_{n , max}}} \qquad ( 3 )$$

In equation 3 “σ_{n,min}” is the minimum stress and “σ_{n,max}” is the maximum stress. First, the stress tensors from 675-point probes are collected from the finite element analysis. The stress levels and the cycles are then obtained from the Simplified Rainflow Counting algorithm. The number of cycles for crack initiation (Nᵢ) is computed for each probe. To address the missing data due to coarse probe settings, a Gaussian Process surrogate is used to predict the locations across, for example, all positions and angles of a pipe. With the given state (current accumulated cycles and power level), the required number of cycles for crack initiation can be predicted.

In equation 3, the stress intensity factor K(σₙ, aₙ) can be computed in various ways and may depend on the geometry of the initial crack and the geometry of the structure being studied. For example, assuming a surface crack with size 1/10^{th} of a pipe thickness pre-existed, the stress intensity factor K(σₙ,aₙ) can be computed, for example, using Equations 4-6 below, however, example embodiments are not limited thereto:

$$K ( {σ}_{n} , {a}_{n} ) = ( {σ}_{m} {M}_{m} + {σ}_{b} {M}_{b} ) \sqrt{\frac{π {a}_{n}}{Q}} \qquad ( 4 )$$

$$Q = 1 + 4.593 {( \frac{{a}_{n}}{l} )}^{1.65} - {q}_{y} \qquad ( 5 )$$

$${q}_{y} = {( \frac{{σ}_{m} {M}_{m} + {σ}_{b} {M}_{b}}{{σ}_{y e i l d}} )}^{2} / 6 \qquad ( 6 )$$

In Equations 4-6 Om membrane stress and σ_{b} bending stress can be obtained from the stress tensor of the Finite Element Analysis (FEA). Mm and Mb can be obtained from the American Society of Mechanical Engineers (ASME) Boiler & Pressure Vessel Code (BPVC) code BPVC.XI.1-2013. These modeling techniques may be applied to a plurality of model points in the digital twin of the physical structure to model fatigue and damage accumulation at these model points.

At S150, the device 900 may identify at least one critical location on the physical structure based on the at least one model. A threshold for accumulated fatigue and/or damage may be used to determine if a model point on the digital twin of the physical structure is a critical location. For example, a threshold of a prediction of fatigue leading to an 80% chance of a crack initiating may be a threshold. Or as another example, a threshold of predicted damage of a crack larger than 10 cm may be a threshold.

The predicted damage may include surface cracks and/or sub-surface cracks. The cracks may be predicted in pipes, fittings, seals, support structures, etc. Other types of damage may also be predicted such as generator failure, sensor dismounting, etc.

At S170, the device 900 may generate one or more outputs based on the predicted fatigue and damage accumulation at the identified critical location. For example, the device 900 may generate a work order and/or an alarm based on the identified critical location. The alarm may be a displayed alarm, an audio alarm, a printed alarm, and/or an electronically communicated alarm (e.g., email, alert message, or other communication to other devices). The work order may also be displayed, printed, or electronically communicated. The work order may indicate a critical location and what repairs are needed (e.g., visual or sensor assisted damage assessment, patch, and replacement).

Alternatively, or additionally, the output may include controlling a device to change a condition at the physical structure based on the identified critical location and the at least one model. For example, if the at least one model predicts a crack larger than 10 cm if the physical structure continues to operate at 100% power, a command may be sent from the device 900 to the controller 700 to lower the operational level to 70% until the real-world damage can be assessed and/or repairs can be performed. Accordingly, a work order may be generated in addition to the control of the device.

New operation information may be received in real time or at certain intervals (such as daily or hourly), the at least one model, the predicted fatigue and damage and the outputs may be updated based on the new operation information. For example, if due to lower-than-expected demand, the operational level of the physical structure was reduced (from a planned or predicted operational level) the operation information received will reflect the lower operational level and the predicted fatigue and damage may be adjusted to be lower than previously predicted based on the operational information. As another example, if due to increased demand or another facility going offline, an operational level of the physical structure may be increased and the operation information received will reflect the higher operational level and the predicted fatigue and damage may be adjusted to be higher than previously predicted based on the operational information. Thus, based on received operation information the identified critical location and the output may be updated, or changed.

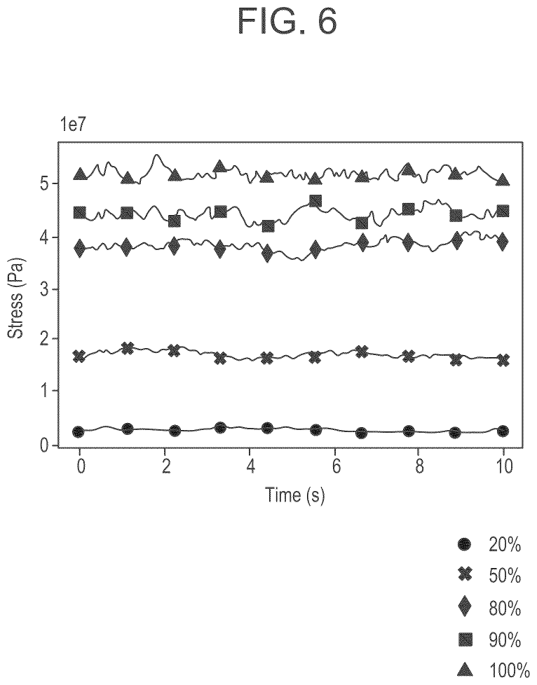

FIG. 6 is a an example of historical data at different power levels. The historical data is presented in the form of a graph with data for operation of the physical structure at power levels of 20%, 50%, 80%, 90%, and 100%. The historical data may be organized in time versus stress. Stress being a measure of force, temperature change, or another form of stress on the physical structure.

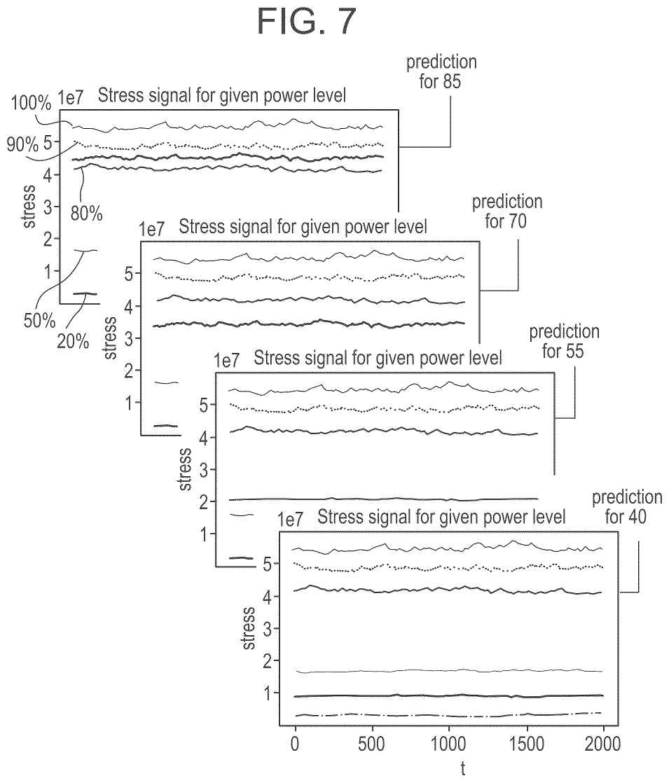

FIG. 7 is an example of simulated stress at different power levels. The stress may be predicted for operation of the physical structure at a given power level based on the historical data. For example, predications may be made for lower levels at 85%, 70%, 55%, and 40%. The prediction can be made by interpreting and interpolating the historical data from multiple power levels using autoregressive time series models. For example, to predict the stress at 85%, the stress levels at 80% and 90% may be used to predict the stress at 85%.

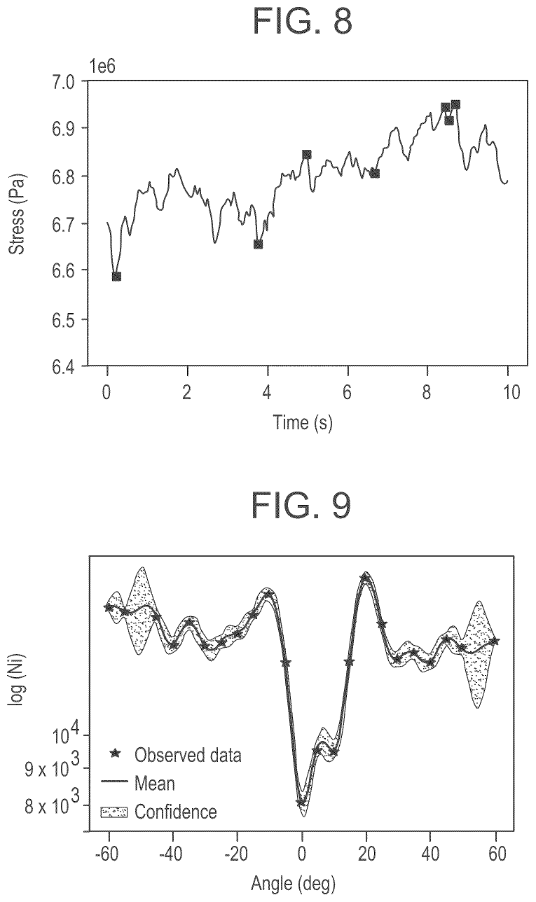

FIG. 8 is an example of rainflow counting and detected cycles. The stress at a point may be measured as pressure (pascals) over a number of seconds. Cycles may be identified with the boxes placed over the pressure graph. The cycles may be identified by, for example, identifying four turning points (A, B, C, D) in the signal (where the gradient changes sign-stress trend changes from downward to upward and vice versa) and consider the period A-D as a rainflow cycle, then proceeding with the remaining of the signal.

FIG. 9 is an example of uncertainty quantification for identifying critical locations for crack initiation. The graph shows the number of cycles for crack initiation at a location on a pipe at different angles of the pipe. A lower number meaning fewer cycles until a crack initiates (i.e., a more critical situation). The position of the zero degrees may be selected as a location with a modeled high stress area. The observed data is indicated with stars, the mean data is indicated with the dark line and the confidence is indicated with the shaded region.

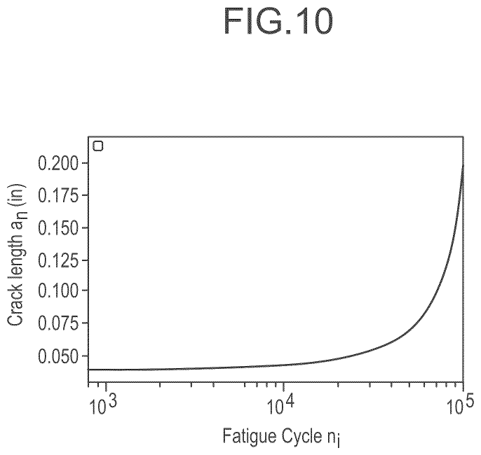

FIG. 10 is an example of propagation of a crack over time cycles. The graph shows the number of cycles vs. crack length where, as shown, the length of a crack increases as the number of cycles increases. The figure also shows a mean crack propagation curve (solid line) and uncertainty bands around it (shading around the solid line). These uncertainty bands are quantified by considering the uncertainty incoming from the crack initiation phase (uncertainty in Nᵢ—see FIG. 9), as well the uncertainty in the initial crack size, material properties, and a noise term. Using a particle fly forward approach, samples from the probability distributions of the uncertain parameters are drawn and propagated forward in the crack propagation phase. The results are crack propagation curves with multiple rates/slopes. The confidence/uncertainty bands shown in FIG. 10 are a manifestation of the standard deviation of these multiple crack propagation curves.

As discussed above, due to the high frequency and the nature of the complex turbulence, it may be difficult to assess the damage caused by flow-induced thermal fatigue using in-plant instrumentation. Accordingly, the high-fidelity digital twin according to example embodiments is able to develop prognostic and diagnostic maintenance approaches by using STRUCT as the foundation of the high-fidelity digital twin. Example embodiments are able to utilize STRUCT to make multi-scale, multi-physics simulations to evaluate thermal mixing. The high-fidelity virtual model may be integrated with the diagnosis and prognosis models to compute crack initiation and propagation of a component, where crack evolutions across all positions and angles of the component can be assessed and monitored with a given operation condition, and this information can be utilized to make decisions regarding operational and maintenance activities.

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims. In addition, while processes have been disclosed herein, it should be understood that the described elements of the processes may be implemented in different orders, using different selections of elements, some combination thereof, etc. For example, some example embodiments of the disclosed processes may be implemented using fewer elements than that of the illustrated and described processes, and some example embodiments of the disclosed processes may be implemented using more elements than that of the illustrated and described processes.

What is claimed is:

1. A method of identifying at least one critical location on a physical structure, the method comprising:
receiving operational information, the operational information being information related to an operation of the physical structure, the operational information including different time instances of the operation of the physical structure and the operation of the physical structure at different operational levels, the operational levels relating to levels of output from the physical structure, at least a portion of the operational information being received from sensors sensing a condition of the physical structure;
predicting damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations; and
identifying the at least one critical location on the physical structure based on the predicted damage.

2. The method of claim 1, further comprising:
generating a work order or alarm based on the at least one critical location and the at least one model.

3. The method of claim 1, wherein the at least one model includes one or more machine learning regression models or machine learning time-series models.

4. The method of claim 1, wherein the operational information includes available time series data indicating stress or material temperature within the physical structure and unavailable time series data where stress or material temperature within the physical structure is unknown, and wherein the predicting damage to the physical structure comprises predicting initial damage to the physical structure by:
interpolating the operational information to forecast additional operational information at a same location or angle on the physical structure across the different operational levels of the physical structure associated with the unavailable time series data; and
concatenating the operational information and the additional operational information for a specified prediction time period to generate complete operational information.

5. The method of claim 4, wherein the predicting the initial damage to the physical structure further includes:
performing rainflow counting (RC) using a simplified RC algorithm to count a number of cycles in the complete operational information;
estimating a number of cycles to initiation of the damage at locations or angles of the physical structure where the operational information or the additional operational information is available;
predicting a number of cycles to initiation of the damage at different locations or angles where the complete operational information is unavailable by using machine learning models to quantify a level of uncertainty in the number of cycles to initiation of the damage; and
calculating damage fraction at each cycle of the number of cycles in in the complete operational information using
$$D = {\sum }_{i = 1}^{k} \frac{{n}_{i}}{{N}_{i}} ≪ 1 ,$$
wherein “D” is the damage fraction, “k” is a number of stress levels, “nᵢ” is a number of accumulated cycles, and “Nᵢ” is the number of cycles to the initiation of the damage at an i-th stress.

6. The method of claim 4, wherein the initial damage includes at least one of fatigue damage, creep damage, oxidation damage, or wear damage of the physical structure, the fatigue damage including a surface crack or a subsurface crack in the physical structure.

7. The method of claim 4, wherein the predicting damage to the physical structure further comprises predicting growth of the initial damage to the physical structure over time based on:
$$\frac{d {a}_{n}}{d n} = c {{K}_{eff} ( {a}_{n} )}^{m}$$
where “aₙ” is crack length under cycle n and includes a level of uncertainty in the number of cycles to initiation of the damage, “c” and “m” are material coefficients with a level of uncertainty for the physical structure, “K_{eff}” is an effective stress intensity factor computed based on a stress level (On) and a crack geometry using
$${K}_{eff} = K ( {σ}_{n} , {a}_{n} ) \sqrt{1 - \frac{{σ}_{n , min}}{{σ}_{n , max}}}$$
where “σ_{n,min}” is a minimum stress and “σ_{n,max}” is a maximum stress, and K(σₙ, σₙ) is a stress intensity factor that varies based on a geometry of the initial damage to the physical structure and the physical structure.

8. The method of claim 1, wherein the predicting damage to the physical structure is further based on operating a digital twin of the physical structure, the digital twin being an electronically generated model of the physical structure.

9. The method of claim 1, wherein the condition of the physical structure includes temperature data and flow rate data, and the method further comprises:
updating the condition of the physical structure at the at least one critical location; and
updating the at least one model based on the updated condition of the physical structure at the at least one critical location.

10. The method of claim 1, wherein the physical structure is included in a nuclear power plant that further includes a nuclear reactor, and the operational levels are power output levels of the nuclear reactor.

11. The method of claim 1, wherein the operational information includes repair and installation details for the physical structure.

12. The method of claim 1, further comprising:
controlling a device to change the condition at the physical structure based on the at least one critical location and the at least one model.

13. A device configured to identify at least one critical location on a physical structure, comprising:
processing circuitry configured to,
receive operational information, the operational information being information related to an operation of the physical structure, the operational information including different time instances of the operation of the physical structure and the operation of the physical structure at different operational levels, the operational levels relating to levels of output from the physical structure, at least a portion of the operational information being received from sensors sensing a condition of the physical structure,
predict damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations, and
identify the at least one critical location on the physical structure based on the at least one model.

14. The device of claim 13, wherein the processing circuitry is further configured to:
generate a work order or alarm based on the at least one critical location and the at least one model.

15. The device of claim 13, wherein the at least one model includes one or more machine learning regression models or machine learning time-series models.

16. The device of claim 13, wherein the operational information includes available time series data indicating stress or material temperature within the physical structure and unavailable time series data where stress or material temperature within the physical structure is unknown, and wherein the processing circuitry is configured to predict the damage to the physical structure by predicting at least initial damage to the physical structure by:
interpolating the operational information to forecast additional operational information at a same location or angle on the physical structure across the different operational levels of the physical structure associated with the unavailable time series data; and
concatenating the operational information and the additional operational information for a specified prediction time period to generate complete operational information.

17. The device of claim 16, wherein the processing circuitry is configured to predict the initial damage to the physical structure by further:
performing rainflow counting (RC) using a simplified RC algorithm to count a number of cycles in the complete operational information;
estimating a number of cycles to initiation of the damage at locations or angles of the physical structure where the operational information or the additional operational information is available,
predicting a number of cycles to initiation of the damage at different locations or angles where the complete operational information is unavailable by using machine learning models to quantify a level of uncertainty in the number of cycles to initiation of the damage; and
calculating damage fraction at each cycle of the number of cycles in in the complete operational information using
$$D = {\sum }_{i = 1}^{k} \frac{{n}_{i}}{{N}_{i}} ≪ 1 ,$$
wherein “D” is the damage fraction, “k” is a number of stress levels, “nᵢ” is a number of accumulated cycles, and “Nᵢ” is the number of cycles to the initiation of the damage at an i-th stress.

18. The device of claim 16, wherein
the predicting damage to the physical structure is further based on operating a digital twin of the physical structure, the digital twin being an electronically generated model of the physical structure, and
the initial damage includes at least one of fatigue damage, creep damage, oxidation damage, or wear damage of the physical structure, the fatigue damage including a surface crack or a subsurface crack in the physical structure.

19. The device of claim 13, wherein the processing circuitry is further configured to:
control another device to change the condition at the physical structure based on the at least one critical location and the model.

20. A non-transitory computer readable medium including instructions thereon, which when executed by a processor cause the processor to:
receive operational information, the operational information being information related to an operation of a physical structure, the operational information including different time instances of the operation of the physical structure and the operation of the physical structure at different operational levels, the operational levels relating to levels of output from the physical structure, at least a portion of the operational information being received from sensors sensing a condition of the physical structure,
predict damage to the physical structure based on the operational information, predicted operation of the physical structure with at least one of the different operational levels, and at least one model of the physical structure such that initiation of the damage at a plurality of locations of the physical structure is predicted independent of a proximity of the sensors to each of the plurality of locations, and
identify at least one critical location on the physical structure based on the at least one model.
